(19) United States
(12) Patent Application Publication
(10) Pub. No.: US 2019/0130528 A1
(43) Pub. Date: May 2, 2019

(54) METHOD OF UPSAMPLING BASED ON MAXIMUM-RESOLUTION IMAGE AND COMPOSITING RGB IMAGE, AND APPARATUS PERFORMING THE SAME

(71) Applicant: Electronics and Telecommunications Research Institute, Daejeon (KR)

(72) Inventors: Tae Jung KIM, Daejeon (KR); Do-Seob AHN, Daejeon (KR); Ilgu JUNG, Daejeon (KR)

(73) Assignee: Electronics and Telecommunications Research Institute, Daejeon (KR)

(21) Appl. No.: 15/962,411

(22) Filed: Apr. 25, 2018

(30) Foreign Application Priority Data
Nov. 1, 2017 (KR) 10-2017-0144785

(51) Int. Cl. G06T 3/40

(52) U.S. Cl. CPC G06T 3/4007; G06T 3/4053; G06T 3/403

(57) ABSTRACT

Disclosed are a method of upsampling based on a maximum-resolution image and red, green and blue (RGB) composition and an apparatus performing the same. An image generating method may include acquiring visible-channel images included in multi-spectrum images, upsampling a remaining image excluding a maximum-resolution image from the visible-channel images, based on the maximum-resolution image among the visible-channel images, and generating an RGB composite image by composing the upsampled remaining image and the maximum-resolution image.

### CROSS-REFERENCE TO RELATED APPLICATION(S)

This application claims the priority benefit of Korean Patent Application No. 10-2017-0144785 filed on Nov. 1, 2017, in the Korean Intellectual Property Office, the disclosure of which is incorporated herein by reference for all purposes.

### BACKGROUND

### 1. Field

One or more example embodiments relate to a method of efficient upsampling and improved red, green and blue (RGB) composition with respect to multi-channel images generated from images acquired by a satellite, a scanner, or a multi- or high-spectrum image generator.

### 2. Description of Related Art

With the development of a satellite system, modern people may access satellite images anytime and anywhere through the Internet or broadcasts.

In particular, a meteorological satellite generates and services high-resolution weather images using developed sensors. The weather images are utilized by professional or non-professional intellectuals as important information for weather forecast.

Red-, green-, and blue-channel image data of the weather images are utilized as important visible images, and particularly utilized to generate an RGB composite image.

In the traditional RGB composition, in a case in which images have different resolutions, an RGB composite image is generated by downsampling the images with the lowest image resolution to minimize an error.

### SUMMARY

An aspect provides efficient upsampling technology and red, green and blue (RGB) composite image generating technology with respect to multi-spectrum images having different resolutions.

Another aspect also provides technology for upsampling a low-resolution image of an adjacent channel with a maximum resolution by fully utilizing maximum-resolution images.

According to an aspect, there is provided an image generating method including acquiring visible-channel images included in multi-spectrum images, upsampling a remaining image excluding a maximum-resolution image from the visible-channel images, based on the maximum-resolution image among the visible-channel images, and generating an RGB composite image by composing the upsampled remaining image and the maximum-resolution image.

The acquiring may include quantizing the visible-channel images.

The upsampling may include generating an extended array by extending the remaining image, and interpolating an empty space region of the extended array based on the maximum-resolution image.

The extended array may include a region of pixels included in the remaining image and the empty space region generated between the pixels.

The interpolating may include calculating a pixel value to be used to interpolate the empty space region based on pixel values of pixels adjacent to the empty space region among the pixels and a pixel value of the maximum-resolution image corresponding to the empty space region.

The calculating may include calculating a first predicted value based on a mean value of differences of the pixels adjacent to the empty space region and the pixel value of the maximum-resolution image corresponding to the empty space region, calculating a second predicted value based on the pixel values of the adjacent pixels, and calculating the pixel value to be used to interpolate the empty space region based on the first predicted value and the second predicted value.

The empty space region may include a horizontal region of a horizontal position, a vertical region of a vertical position, and a center region of a center position based on positions of the pixels.

The pixel values of the pixels adjacent to the empty space region may be pixel values of pixels immediately adjacent to the horizontal region among the pixels in a case of interpolating the horizontal region, pixel values of pixels immediately adjacent to the vertical region among the pixels in a case of interpolating the vertical region, and pixel values of all the pixels in a case of interpolating the center region.

According to another aspect, there is provided an image generating apparatus including a receiver configured to receive multi-spectrum images, and a controller configured to upsample a remaining image excluding a maximum-resolution image from visible-channel images included in the multi-spectrum images, based on the maximum-resolution image among the visible-channel images, and generate an RGB composite image by composing the upsampled remaining image and the maximum-resolution image.

The controller may include a quantizer configured to quantize the visible-channel images.

The controller may further include an upsampler configured to generate an extended array by extending the remaining image, and interpolate an empty space region of the extended array based on the maximum-resolution image.

The extended array may include a region of pixels included in the remaining image and the empty space region generated between the pixels.

The upsampler may be configured to calculate a pixel value to be used to interpolate the empty space region based on pixel values of pixels adjacent to the empty space region among the pixels and a pixel value of the maximum-resolution image corresponding to the empty space region.

The upsampler may be configured to calculate a first predicted value based on a mean value of differences of the pixels adjacent to the empty space region and the pixel value of the maximum-resolution image corresponding to the empty space region, calculate a second predicted value based on the pixel values of the adjacent pixels, and calculate the pixel value to be used to interpolate the empty space region based on the first predicted value and the second predicted value.

The empty space region may include a horizontal region of a horizontal position, a vertical region of a vertical position, and a center region of a center position based on positions of the pixels.

The pixel values of the pixels adjacent to the empty space region may be pixel values of pixels immediately adjacent to the horizontal region among the pixels in a case of interpolating the horizontal region, pixel values of pixels immediately adjacent to the vertical region among the pixels in a case of interpolating the vertical region, and pixel values of all the pixels in a case of interpolating the center region.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating an image generating apparatus according to an example embodiment;

FIG. 2 illustrates a method of maximum resolution upsampling and red, green and blue (RGB) composite image generation according to an example embodiment;

FIG. 3 is a block diagram illustrating a controller of FIG. 1;

FIG. 4 illustrates an upsampling operation of an upsampler of FIG. 3; and

FIG. 5 is a flowchart illustrating a method of generating an RGB composite image according to an example embodiment.

### DETAILED DESCRIPTION

The following structural or functional descriptions are exemplary to merely describe the example embodiments, and the scope of the example embodiments is not limited to the descriptions provided in the present specification. Various changes and modifications can be made thereto by those of ordinary skill in the art.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component or intervening components may be present.

As used herein, the singular forms are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

Hereinafter, the example embodiments will be described in detail with reference to the accompanying drawings. However, the scope of the present application is not limited to the example embodiments. In the drawings, like reference numerals are used for like elements.

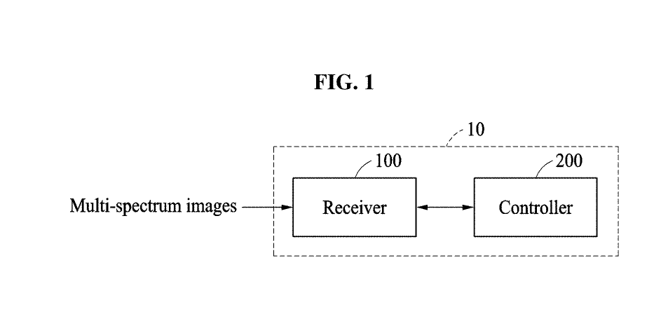

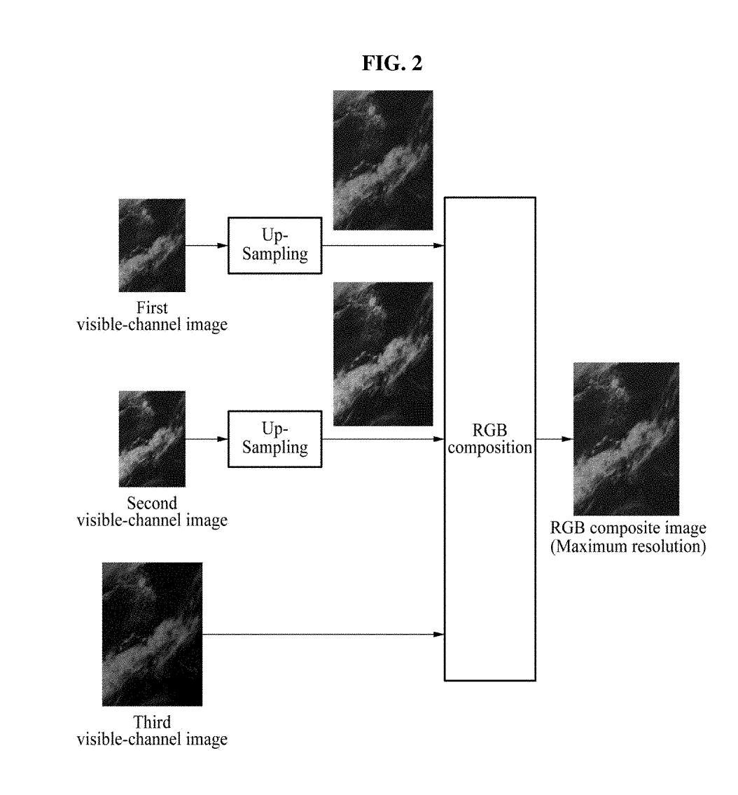

FIG. 1 is a block diagram illustrating an image generating apparatus according to an example embodiment, and FIG. 2 illustrates a method of maximum resolution upsampling and red, green and blue (RGB) composite image generation according to an example embodiment.

Referring to FIGS. 1 and 2, an image generating apparatus 10 may perform an effective upsampling and RGB composite image generating method in a case in which visible-channel images included in multi-spectrum images or high-spectrum images have different resolutions. The image generating apparatus 10 may include a receiver 100 and a controller 200. The receiver 100 may receive the multi-spectrum images. The multi-spectrum images may be generated from images acquired by satellites or sensors that generate images of various wavelengths, for example, a multi-spectrum sensor, a high-spectrum sensor, and a scanner. For example, the multi-spectrum images may include images having different wavelengths at the same point in time in the same time slot. In this example, the multi-spectrum images may have different resolutions for each wavelength range.

The controller 200 may generate an RGB composite image using the visible-channel images included in the multi-spectrum images. In this example, the controller 200 may upsample the visible-channel images based on a maximum-resolution image of the visible-channel images, and generate a maximum-resolution RGB composite image using the upsampled images.

First, the controller 200 may select the maximum-resolution image from the visible-channel images. The controller 200 may upsample a remaining image, for example, a remaining visible-channel image excluding the maximum-resolution image from the visible-channel images, based on the maximum-resolution image.

Then, the controller 200 may generate the RGB composite image by composing the upsampled remaining image and the maximum-resolution image.

As shown in FIG. 2, the visible-channel images may include a first visible-channel image, a second visible-channel image, and a third visible-channel image. The first visible-channel image may be a blue-channel image, the second visible-channel image may be a green-channel image, and the third visible-channel image may be a red-channel image. The controller 200 may upsample the blue-channel image and the green-channel image using the red-channel image having a greatest resolution. Then, the controller 200 may generate an RGB composite image by composing the upsampled blue-channel image, the upsampled green-channel image, and the red-channel image.

The image generating apparatus 10 may perform the upsampling operation by fully and efficiently utilizing information of the maximum-resolution image, and generate the RGB composite image based on a maximum resolution, thereby providing a maximum-resolution RGB composite image.

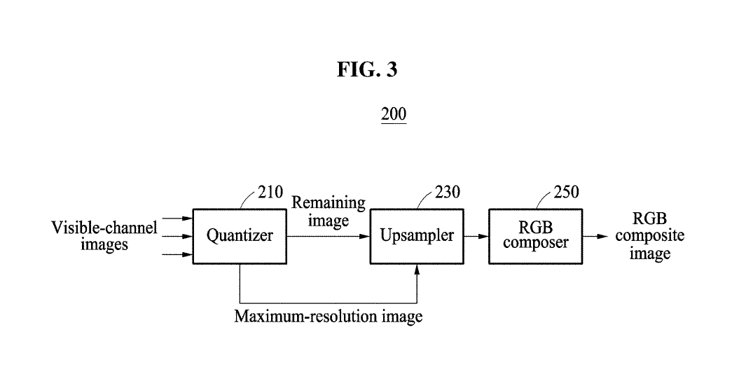

FIG. 3 is a block diagram illustrating the controller of FIG. 1.

Referring to FIG. 3, the controller 200 may include a quantizer 210, an upsampler 230, and an RGB composer 250.

The quantizer 210 may quantize visible-channel images. Visible-channel images of different wavelengths may have different resolutions and different data sizes, for example, bit depths. The quantizer 210 may generate images of the same data size, for example, bit depth, by quantizing the visible-channel images.

The quantizer 210 may output the quantized visible-channel images, that is, the visible-channel images of the same data size, to the upsampler 230.

The upsampler 230 may select a high-resolution or maximum-resolution image from the visible-channel images. The upsampler 230 may generate an extended array by extending a remaining image.

The extended array may include a region of pixels included in the remaining image. The region of the pixels included in the remaining image may be extended and disposed in a region at a predetermined position of the extended array. Thus, an empty space region may be generated between pixels extended in the extended array and disposed in the region at the predetermined position. That is, the extended array may include the region of the pixels constituting the remaining image and the empty space region generated between the pixels.

The upsampler 230 may interpolate the empty space region of the extended array based on the maximum-resolution image. For example, the upsampler 230 may calculate a pixel value to be used to interpolate the empty space region based on pixel values of pixels adjacent to the empty space region among the pixels included in the remaining image and a pixel value of the maximum-resolution image corresponding to the empty space region.

In this example, the empty space region may include a horizontal region of a horizontal position, a vertical region of a vertical position, and a center region of a center position based on positions of the pixels in the extended array. That is, the upsampler 230 may calculate pixel values to be used to interpolate the horizontal region, the vertical region, and the center region.

Hereinafter, it may be assumed for ease of description that four pixels are included in the remaining image. However, example embodiments are not limited thereto. The number of pixels included in the remaining image may be greater than or equal to “1”.

The upsampler 230 may calculate the pixel value to be used to interpolate the horizontal region of the empty space region using Equation 1.

H(i,j)=ω₁P(i−1,j)+ω₂P(i+1,j)+ω₀PredH(i,j) [Equation 1]

In Equation 1, ω₀PredH(i,j) denotes a value predicted using a pixel value of the maximum-resolution image corresponding to the horizontal region. ω₁P(i−1,j) and ω₂P(i−1,j) denote values predicted using pixel values of pixels immediately adjacent to the horizontal region. ωₙ denotes a weight value, and the weight value may be set.

The upsampler 230 may calculate ω₀PredH(i,j) using Equation 2.

$$PredH ( i , j ) = R ( i , j ) + \frac{1}{k} {\sum }_{n = - 1 or 1} P ( i + n , j ) - R ( i + n , j ) \qquad [ Equation 2 ]$$

That is, the upsampler 230 may calculate a first predicted value based on a mean value of differences of the pixels adjacent to the horizontal region and the the pixel value of the maximum-resolution image corresponding to the horizontal region.

As in Equation 1, the upsampler 230 may calculate the pixel value to be used to interpolate the horizontal region based on the predicted values.

The upsampler 230 may calculate the pixel value to be used to interpolate the vertical region of the empty space region using Equation 3.

V(i,j)=ω₁P(i,j−1)+ω₂P(i,j+1)+ω₀PredV(i,j) [Equation 1]

In Equation 3, ω₀PredV(i,j) denotes a value predicted using a pixel value of the maximum-resolution image corresponding to the vertical region. ω₁P(i,j−1) and ω₂P(i,j−1) denote values predicted using pixel values of pixels immediately adjacent to the vertical region. ωₙ denotes a weight value, and the weight value may be set.

The upsampler 230 may calculate ω₀PredV(i,j) using Equation 4.

$$PredV ( i , j ) = R ( i , j ) + \frac{1}{k} {\sum }_{m = - 1 or 1} P ( i , j + m ) - R ( i , j + m ) \qquad [ Equation 4 ]$$

That is, the upsampler 230 may calculate a predicted value based on a mean value of differences of the pixels adjacent to the vertical region and the pixel value of the maximum-resolution image corresponding to the vertical region.

As in Equation 3, the upsampler 230 may calculate the pixel value to be used to interpolate the vertical region based on the predicted values.

The upsampler 230 may calculate the pixel value to be used to interpolate the center region of the empty space region using Equation 5.

$$C ( i , j ) = {ω}_{1} P ( i + 1 , j - 1 ) + {ω}_{2} P ( i - 1 , j + 1 ) + {ω}_{3} P ( i + 1 , j - 1 ) + {ω}_{4} P ( i + 1 , j + 1 ) + {ω}_{0} PredC ( i , j ) \qquad [ Equation 5 ]$$

In Equation 5, ω₀PredC(i,j) denotes a value predicted using a pixel value of the maximum-resolution image corresponding to the center region. ω₁P(i−1,j−1), ω₂P(i−1,j+1), ω₂P(i+1,j−1), and ω₂P(i+1,j+1) denote values predicted using pixel values of pixels immediately adjacent to the center region. ωₙ denotes a weight value, and the weight value may be set.

The upsampler 230 may calculate ω₀PredC(i,j) using Equation 6.

$$PredC ( i , j ) = R ( i , j ) + \frac{1}{k} {\sum }_{n , m = - 1 or 1} P ( i + n , j + m ) - R ( i + n , j + m ) \qquad [ Equation 6 ]$$

That is, the upsampler 230 may calculate a predicted value based on a mean value of differences of the pixels adjacent to the center region and the pixel value of the maximum-resolution image corresponding to the center region.

As in Equation 5, the upsampler 230 may calculate the pixel value to be used to interpolate the center region based on the predicted values.

As described above, the upsampler 230 may upsample the remaining image based on the pixel values of the remaining image to be upsampled and the pixel values of the maximum-resolution image.

The RGB composer 250 may generate an RGB composite image by composing the upsampled remaining image and the maximum-resolution image. The maximum-resolution image may be transmitted from the quantizer 210 and/or the upsampler 230.

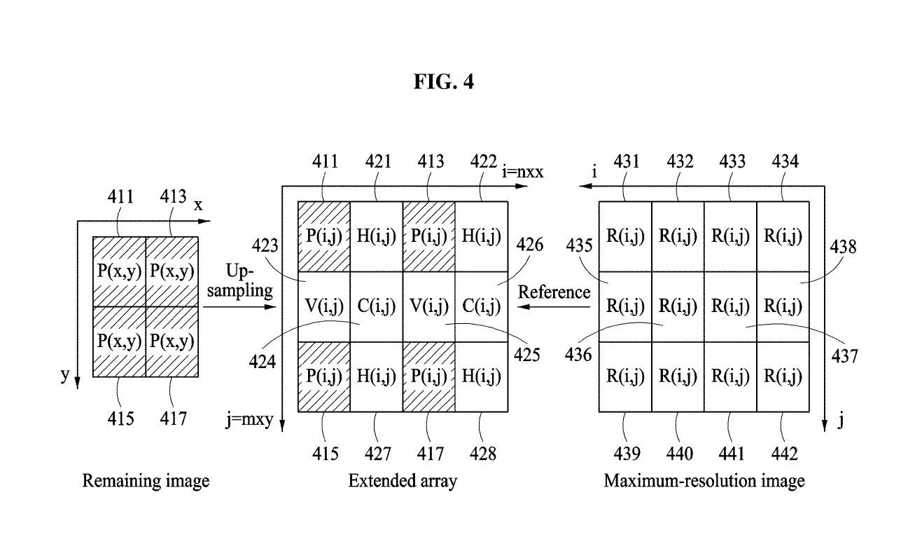

FIG. 4 illustrates an upsampling operation of the upsampler of FIG. 3.

For ease of description, it may be assumed that a remaining image includes four pixels 411 through 417, and a maximum-resolution image which is a reference image includes twelve pixels 431 through 442.

Referring to FIGS. 3 and 4, the upsampler 230 may generate an extended array by extending the remaining image to be upsampled to nXm.

A pixel value to be used to interpolate a horizontal region 421 may be calculated based on pixel values of pixels 411 and 413 adjacent to the horizontal region 421 and a pixel value of a pixel 432 of a maximum-resolution image corresponding to the horizontal region 421, and used to interpolate the horizontal region 421. The other horizontal regions 422, 427 and 428 may also be interpolated in the same manner.

A pixel value to be used to interpolate a vertical region 423 may be calculated based on pixel values of pixels 411 and 415 adjacent to the vertical region 423 and a pixel value of a pixel 435 of the maximum-resolution image corresponding to the vertical region 423, and used to interpolate the vertical region 423. The other vertical region 425 may also be interpolated in the same manner.

A pixel value to be used to interpolate a center region 424 may be calculated based on pixel values of pixels 411, 413, 415 and 417 adjacent to the center region 424 and a pixel value of a pixel 436 of the maximum-resolution image corresponding to the center region 424, and used to interpolate the center region 424. The other center region 426 may also be interpolated in the same manner.

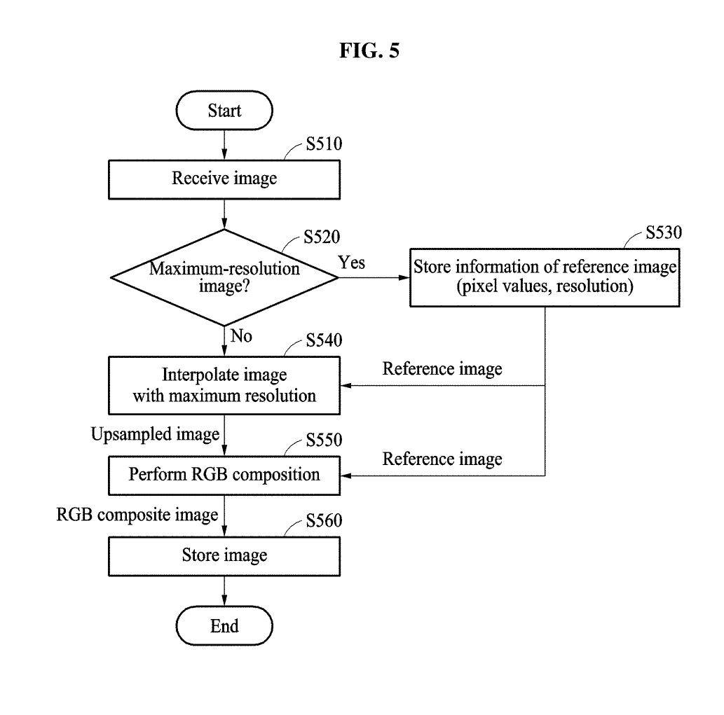

FIG. 5 is a flowchart illustrating a method of generating an RGB composite image according to an example embodiment.

Referring to FIG. 5, in operation S510, the controller 200 may receive an image. In operation S520, the controller 200 may determine whether the received image is a high-resolution or maximum-resolution image.

In a case in which the received image is a maximum-resolution image, the controller 200 may store the maximum-resolution image as a reference image to be used for an upsampling operation, in operation S530. For example, the controller 200 may store pixel values of pixels included in the maximum-resolution image, and a resolution of the maximum-resolution image.

In a case in which the received image is not a maximum-resolution image, the controller 200 may upsample, that is, interpolate the received image with a high resolution or maximum resolution based on the maximum-resolution image stored as the reference image, in operation S540. In this example, the controller 200 may use the stored pixel values of the pixels included in the maximum-resolution image, and the stored resolution of the maximum-resolution image.

In operation S550, the controller 200 may generate an RGB composite image by composing the upsampled or interpolated image and the maximum-resolution image.

In operation S560, the controller 200 may store the RGB composite image.

The components described in the example embodiments of the present invention may be achieved by hardware components including at least one Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the processes described in the example embodiments of the present invention may be achieved by software, and the software may be recorded on a recording medium. The components, the functions, and the processes described in the example embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The method according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image generating method, comprising:
acquiring visible-channel images included in multi-spectrum images;
upsampling a remaining image excluding a maximum-resolution image from the visible-channel images, based on the maximum-resolution image among the visible-channel images; and
generating a red, green and blue (RGB) composite image by composing the upsampled remaining image and the maximum-resolution image.

2. The image generating method of claim 1, wherein the acquiring comprises quantizing the visible-channel images.

3. The image generating method of claim 2, wherein the upsampling comprises:
generating an extended array by extending the remaining image; and
interpolating an empty space region of the extended array based on the maximum-resolution image.

4. The image generating method of claim 3, wherein the extended array includes a region of pixels included in the remaining image and the empty space region generated between the pixels.

5. The image generating method of claim 4, wherein the interpolating comprises calculating a pixel value to be used to interpolate the empty space region based on pixel values of pixels adjacent to the empty space region among the pixels and a pixel value of the maximum-resolution image corresponding to the empty space region.

6. The image generating method of claim 5, wherein the calculating comprises:
calculating a first predicted value based on a mean value of differences of the pixels adjacent to the empty space region and the pixel value of the maximum-resolution image corresponding to the empty space region;
calculating a second predicted value based on the pixel values of the adjacent pixels; and
calculating the pixel value to be used to interpolate the empty space region based on the first predicted value and the second predicted value.

7. The image generating method of claim 5, wherein the empty space region includes a horizontal region of a horizontal position, a vertical region of a vertical position, and a center region of a center position based on positions of the pixels.

8. The image generating method of claim 7, wherein the pixel values of the pixels adjacent to the empty space region are:
pixel values of pixels immediately adjacent to the horizontal region among the pixels in a case of interpolating the horizontal region,
pixel values of pixels immediately adjacent to the vertical region among the pixels in a case of interpolating the vertical region, and
pixel values of all the pixels in a case of interpolating the center region.

9. An image generating apparatus, comprising:
a receiver configured to receive multi-spectrum images; and
a controller configured to upsample a remaining image excluding a maximum-resolution image from visible-channel images included in the multi-spectrum images, based on the maximum-resolution image among the visible-channel images, and generate a red, green and blue (RGB) composite image by composing the upsampled remaining image and the maximum-resolution image.

10. The image generating apparatus of claim 9, wherein the controller comprises:
a quantizer configured to quantize the visible-channel images.

11. The image generating apparatus of claim 10, wherein the controller further comprises:
an ups ampler configured to generate an extended array by extending the remaining image, and interpolate an empty space region of the extended array based on the maximum-resolution image.

12. The image generating apparatus of claim 11, wherein the extended array includes a region of pixels included in the remaining image and the empty space region generated between the pixels.

13. The image generating apparatus of claim 12, wherein the upsampler is configured to calculate a pixel value to be used to interpolate the empty space region based on pixel values of pixels adjacent to the empty space region among the pixels and a pixel value of the maximum-resolution image corresponding to the empty space region.

14. The image generating apparatus of claim 13, wherein the upsampler is configured to calculate a first predicted value based on a mean value of differences of the pixels adjacent to the empty space region and the pixel value of the maximum-resolution image corresponding to the empty space region, calculate a second predicted value based on the pixel values of the adjacent pixels, and calculate the pixel value to be used to interpolate the empty space region based on the first predicted value and the second predicted value.

15. The image generating apparatus of claim 13, wherein the empty space region includes a horizontal region of a horizontal position, a vertical region of a vertical position, and a center region of a center position based on positions of the pixels.

16. The image generating apparatus of claim 15, wherein the pixel values of the pixels adjacent to the empty space region are:
pixel values of pixels immediately adjacent to the horizontal region among the pixels in a case of interpolating the horizontal region,
pixel values of pixels immediately adjacent to the vertical region among the pixels in a case of interpolating the vertical region, and
pixel values of all the pixels in a case of interpolating the center region.
